(19) United States
(12) Patent Application Publication
(10) Pub. No.: US 2021/0062573 A1
(43) Pub. Date: Mar. 4, 2021

(54) DOOR FRAME PROTECTION SYSTEM

(71) Applicant: McCue Corporation, Peabody, MA (US)

(72) Inventors: Teodoro A. Mesa, Lynn, MA (US); Evan Oswald, Marblehead, MA (US); David DiAntonio, Andover, MA (US)

(21) Appl. No.: 17/002,933

(22) Filed: Aug. 26, 2020

Related U.S. Application Data
(60) Provisional application No. 62/892,386, filed on Aug. 27, 2019.

(51) Int. Cl. E06B 9/00

(52) U.S. Cl. CPC E06B 9/00; E06B 2009/002

(57) ABSTRACT

An apparatus for use with a frame protection system comprises a coupler including a first inner passage having a first longitudinal axis and a second inner passage having a second longitudinal axis transverse to the first longitudinal axis; and a shock absorber sized and configured to be received within the first inner passage and the second inner passage of the coupler.

### CROSS-REFERENCE TO RELATED APPLICATIONS

This application claims priority to U.S. Provisional Application No. 62/892,386, filed on Aug. 27, 2019, the contents of which are hereby incorporated by reference in their entirety.

### BACKGROUND

This invention relates to an apparatus for protecting a door frame.

Warehouses, distributions centers, factories, and similar facilities often have large stock handling equipment such as fork trucks which frequently move stock into, out of, and around the facility. In some examples, a piece of large stock handling equipment (e.g., a fork truck) retrieves stock from one location in a facility (e.g. from a shelf), transports the stock through the facility to a destination location (e.g., a loading dock). As the fork truck transports the stock through the facility it may pass through a number of doorways in the facility.

The doorways in warehouses, distribution centers, factories, and similar facilities often include shutter-type overhead roll-up doors. These doors include a motorized rolling mechanism installed above the doorway which is used to lower the door into a closed position or to retract the door into an open position. In the open, retracted position, the door is rolled onto a cylinder. Shutter tracks, which guide the shutter-type door as it is lowered and retracted, are often installed on the sides of the doorways.

### SUMMARY

It is often the case that warehouses, distribution centers, factories, and similar facilities have a high amount of stock handling equipment traffic. As operators navigate through the doorways in the facility, the stock handling equipment may occasionally make contact with the door frames of the doorways and certain components of the shutter-type overhead roll-up doors installed thereon. In one example, a fork truck may make contact with the side of the doorway, possibly contacting and damaging the door's shutter tracks. In another example, a fork truck may have its mast deployed to an extent that it makes contact with rolled door and/or the motorized rolling mechanism, possibly causing damage to the door and/or rolling mechanism. In another example, where no shutter-type roll-up door is installed on a doorway, a fork truck may make contact and damage the top or sides of the door frame.

In a general aspect, an apparatus for use with a frame protection system includes a coupler including a first inner passage having a first longitudinal axis and a second inner passage having a second longitudinal axis transverse to the first longitudinal axis; and a shock absorber sized and configured to be received within the first inner passage and the second inner passage of the coupler.

Embodiments of this aspect of the invention may include one or more of the following features.

The first inner passage may have a first dimension and the shock absorber member may include a first protuberance and a second protuberance, the first protuberance and the second protuberance may each have a second dimension commensurate with the first dimension. The first protuberance and the second protuberance may be arcuate in shape, the first dimension may be a first diameter and the second dimension may be a second diameter. The first protuberance and the second protuberance may be diametrically opposed.

In another embodiment, the apparatus further includes a third protuberance and a fourth protuberance, diametrically opposed from the third protuberance, the third protuberance and fourth protuberance angularly spaced by 90 degrees, respectively.

The shock absorber member may include a first shock absorbing member sized and configured to be received within the first inner passage and a second shock absorbing member sized and configured to be received within the second inner passage. The first inner passage and the second inner passage may be defined by a first cylindrical section and a second cylindrical section, respectively, the first cylindrical section and the second cylindrical section.

Among other advantages, the apparatus includes a coupler that provides a shock absorbing dampener, which absorbs impact energy. The apparatus also facilitates assembly of the door frame protection system. For example, connection of the crossbar to the topper does not require welding. Furthermore, the lengths and heights of the crossbar and upright bars, respectively, do not have to be preset and the width and height of the door frame system can be adjusted.

Other features and advantages of the invention are apparent from the following description, and from the claims.

### DESCRIPTION OF DRAWINGS

FIG. 1 illustrates a door frame protection system for use in warehouse setting.

FIG. 2 is a perspective view of the door frame protection system of FIG. 1.

FIG. 3 is an exploded, isometric view of a coupler for use in the door frame protection system of FIG. 1.

FIG. 4 is an end view of the coupler of FIG. 2.

FIG. 5 is cross-sectional side view of a portion of the door frame protection system including the coupler of FIG. 2.

### DETAILED DESCRIPTION

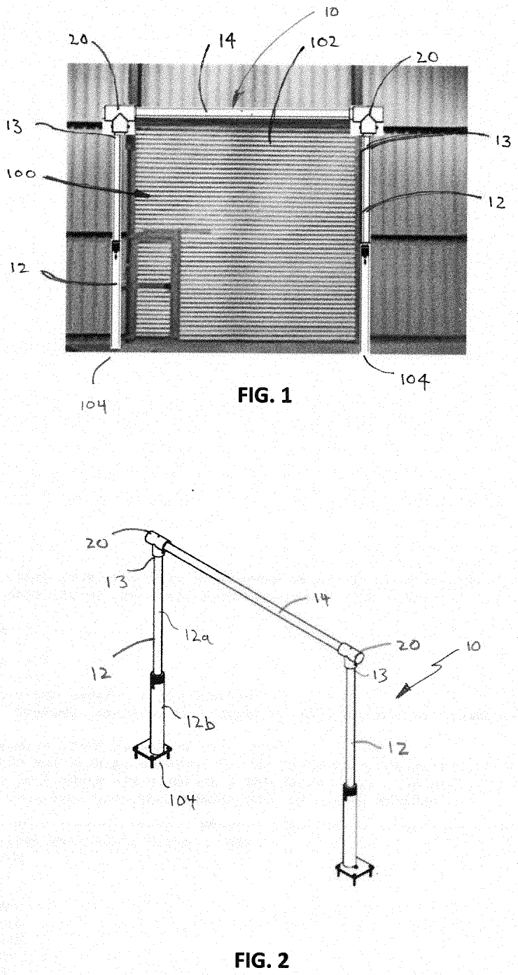

Referring to FIG. 1, a door frame protection system 10 is positioned at the entrance of a warehouse opening 100, which may include a door (e.g., roll-up door) 102. The warehouse opening 100 is generally located at an area of the warehouse where goods are loaded and unloaded. For example, the warehouse opening 100 allows for trucks to back up to the opening where a forklift or pallet truck (neither shown) is used to load or unload goods into and out of the truck through the warehouse opening 100.

Referring to FIG. 2, door frame protection system 10 includes two cylindrical upright bars 12, each of which is anchored into the ground at an anchor point 104. Details the way in which cylindrical upright bars 12 are anchored to the ground and floor can be found in U.S. Pat. No. 9,103,163, which is incorporated herein by reference. Top ends 13 of each of the upright bars 12 are connected by a cylindrical overhead crossbar 14 using couplers 20. Each of the cylindrical upright bars 12 includes an upper section 12a positioned within a lower section 12b in telescoping fashion to allow for the adjusting of the height of crossbar 14 relative to a mounting base 12c.

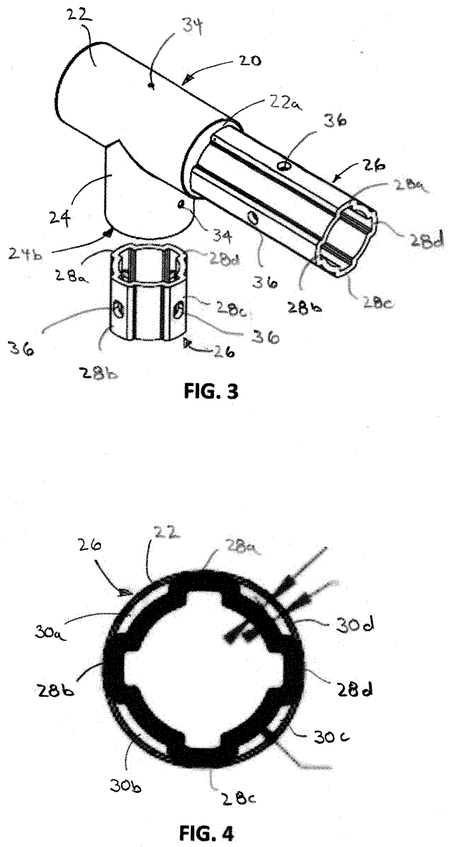

Referring to FIGS. 3 and 4, coupler 20 is T-shaped in that a first cylindrical tube 22 is transverse to a second cylindrical tube 24. Each of first cylindrical tube 22 and second cylindrical tube 24 includes cylindrical inner passages, 22a, 24a, respectively for receiving shock absorbers 26. Inner passages 22a, 24a of first cylindrical tube 22 and second cylindrical tube 24 have inner diameters commensurate with outer diameters of the shock absorbers such that there is a relatively tight fit therebetween. Moreover, first cylindrical tube 22 and second cylindrical tube 24 have sufficient lengths for allowing upper sections 12a of upright bars 12 as well as end portions of overhead crossbar 14 to move therein. This allows for using upright bars and overhead crossbars with imprecise lengths.

In some examples, the cylindrical upright bars 12 and cylindrical overhead crossbar 14 are formed of steel, and coupler 20 is made of a high-density polyethylene (HDPE).

Referring to FIG. 4, in one embodiment, shock absorbers 26 include two pairs of arcuate protuberances 28a,28b, 28c, 28d. Arcuate protuberances 28a and 28c are diametrically opposed from each other. Arcuate protuberances 28b, 28d are also diametrically opposed from each other. The outer diameters of arcuate protuberances 28a,28b, 28c, 28d are slightly less than the inner diameters of first cylindrical tube 22 and second cylindrical tube 24 such that shock absorbers 26 can be positioned within first and second cylindrical tubes 22, 24 with a friction fit. Between each of arcuate protuberances 28a,28b, 28c, 28d are arcuate gaps 30a, 30b, 30c, 30d. Each of arcuate gaps have outer diameters which are less than the outer diameters of arcuate protuberances 28a, 28b, 28c, 28d. With this arrangement, shock absorbers 26 act as dampeners to absorb forces to the door frame protection system due to any impact to upright bars 12, overhead crossbar 14, or coupler 20 itself. For example, if a forklift were to strike one or more of the upright bars 12 or overhead crossbar 14, that force is propagated to absorbers 26 positioned within couplers 20 where the absorbers act as spring-like resilient members. In some embodiments, shock absorbers 26 are formed of ethylene propylene diene monomer (M-class) rubber (i.e., EDPM). In other embodiments, the shock absorbers may be made of high-density polyethylene (HDPE).

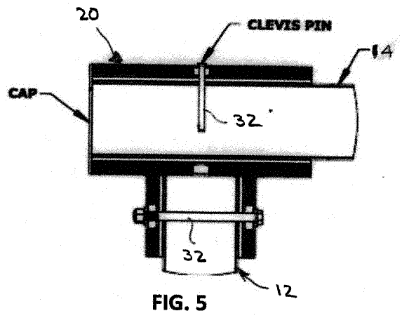

Referring to FIG. 5, and again to FIG. 3, shock absorbers 26 are held within couplers 20 with clevis pins 32, which are positioned within holes 34 of the first and second cylindrical tubes 22, 24 as well as holes 36 of the arcuate protuberances 28a, 28b, 28c, 28d. In positioning shock absorbers 26 within the first and second cylindrical tubes 22, 24, holes 34 and holes 36 are first aligned. The size of holes 36 are enlarged, relative to the size of the clevis pins 32, to allow freedom to laterally adjust absorbers 26 with their respective cylindrical tubes. On the other hand, holes 34 are sized more closely to the size of clevis pins 32 so as to have a friction fit and secure the absorbers within the cylindrical tubes.

### ALTERNATIVES

In some examples, the cylindrical upright bars 12, cylindrical overhead crossbar 14, and coupler 20 are made from an HDPE material having a high visibility color (e.g. yellow). In some examples, the cylindrical upright bars 12, cylindrical overhead crossbar 14, and coupler 20 are colored with an alternating pattern of black and a high visibility color (e.g., horizontally striped).

In some examples where the upright bars and the overhead crossbar are made of metal (e.g., steel), the upright bars and the overhead crossbar are painted with a high visibility paint color (e.g., yellow). In other examples, the upright bars and the overhead crossbar may be made from an HDPE material having a high visibility color.

In some examples, the bolts used to anchor the upright bars to the ground are secured into the ground using an epoxy resin anchor foundation.

It is to be understood that the foregoing description is intended to illustrate and not to limit the scope of the invention, which is defined by the scope of the appended claims. Other embodiments are within the scope of the following claims.

What is claimed is:

1. An apparatus for use with a frame protection system, the apparatus comprising:
a coupler including a first inner passage having a first longitudinal axis and a second inner passage having a second longitudinal axis transverse to the first longitudinal axis; and
a shock absorber sized and configured to be received within the first inner passage and the second inner passage of the coupler.

2. The apparatus of claim 1 wherein the first inner passage has a first dimension and the shock absorber includes a first protuberance and a second protuberance, the first protuberance and the second protuberance each having a second dimension commensurate with the first dimension.

3. The apparatus of claim 2 wherein the first protuberance and the second protuberance are arcuate in shape, the first dimension is a first diameter and the second dimension is a second diameter.

4. The apparatus of claim 3 wherein the first protuberance and the second protuberance are diametrically opposed.

5. The apparatus of claim 4 further comprising a third protuberance and a fourth protuberance, diametrically opposed from the third protuberance, the third protuberance and fourth protuberance angularly spaced by 90 degrees, respectively.

6. The apparatus of claim 1 wherein the shock absorber includes a first shock absorbing member sized and configured to be received within the first inner passage and a second shock absorbing member sized and configured to be received within the second inner passage.

7. The apparatus of claim 2 wherein the first inner passage and the second inner passage are defined by a first cylindrical section and a second cylindrical section, respectively.

8. The apparatus of claim 4 wherein the first protuberance and the second protuberance are angularly spaced by a first inner passage and the second inner passage are defined by a first cylindrical section and a second cylindrical section, respectively, the first cylindrical section and the second cylindrical section together forming an L-shaped coupler.
